(19) United States
(12) Patent Application Publication
(10) Pub. No.: US 2009/0135488 A1
(43) Pub. Date: May 28, 2009

(54) OPTICAL DEVICE AND WAVELENGTH SELECTIVE SWITCH

(75) Inventors: Hirofumi AOTA, Kawasaki (JP); Kohei Shibata, Kawasaki (JP); Tamotsu Akashi, Kawasaki (JP); Tsuyoshi Yamamoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 12/267,232

(22) Filed: Nov. 7, 2008

(30) Foreign Application Priority Data
Nov. 8, 2007 (JP) 2007-291137

(51) Int. Cl. G02B 5/18; G02B 26/08

(52) U.S. Cl. 359/569; 359/298

(57) ABSTRACT

An optical device and a wavelength selector switch are provided. The optical device includes a diffraction grating having first and second planes and first and second reflecting planes located on a first plane side of the diffraction grating. In the optical device, light input to the second plane of the diffraction grating is diffracted, and then an optical path of the diffracted light is re-input to the first plane of the diffraction grating newly via the first and the second reflecting planes.

### CROSS-REFERENCE TO RELATED APPLICATIONS

This application is related to and claims priority to Japanese Patent Application No. 2007-291137, filed on Nov. 8, 2007 and incorporated by reference herein.

### BACKGROUND

1. Field

The embodiments discussed herein are directed to an optical device and a wavelength selective switch, an optical device for performing wavelength dispersion, and a wavelength selective switch for performing switch processing for a light signal on a wavelength basis.

2. Description of the Related Art

In order that rapidly increasing Internet traffic should be accommodated, introduction of optical systems into networks is rapidly progressing where wavelength division multiplexing (WDM) is employed as a core technique.

The present WDM technique may be used in a point-to-point network configuration. However, it is expected that in the near future, the networks develop into ring networks and mesh-shaped networks. Further, even in the individual nodes constituting the networks, processing such as insertion/branching (Add/Drop) of an arbitrary wavelength and optical cross connect (OXC) that does not require conversion into electric signals is expected to be realized. This would permit dynamic path setting/release based on wavelength information.

For the purpose of realizing such optical networks, wavelength selective switches (WSS) and the like that have the function of distributing an input wavelength to an arbitrary output port are attracting attention. At the same time, importance is increasing in optical devices that have the function of performing wavelength dispersion of wavelength multiplexed light.

As an element for wavelength dispersion of wavelength multiplexed light, a diffraction grating of reflection type or transmission type is widely known. FIG. 23 is a diagram illustrating a transmission type diffraction grating. The diffraction grating 100 includes a glass plate provided with fine grooves engraved per unit length. This optical component has the function (wavelength dispersion function) of emitting light beams of wavelength dispersion light (diffracted light) at mutually different diffraction angles θi for individual wavelengths θi when wavelength multiplexed light enters this optical component.

The incident angle of the wavelength multiplexed light onto the diffraction grating 100 is denoted by θa, the grid period (interval of the grooves) of the diffraction grating 100 is denoted by d, and the degree of diffraction is denoted by n. The relation between λi and θi may be expressed as follows in equation (1):

θi=arcsin [(n·λi/d)−sin θa] (1)

A conventional wavelength dispersion technique employs two diffraction gratings for diffracting a light beam twice so as to enhance its angular dispersion. The angular dispersion indicates a diffraction angle difference per wavelength difference for diffracted light beams diffracted by the diffraction grating. Another conventional technique performs wavelength dispersion by using a diffraction grating located between a plurality of reflecting planes.

Wavelengths to be used in WDM communication are standardized by ITU (International Telecommunication Union). These wavelengths are referred to as ITU grid wavelengths. Further, since the wavelengths to be used are predetermined, wavelength intervals between individual channels have also predetermined values.

On the other hand, in an optical communication system that employs an optical device (WDM device) having the function of performing wavelength dispersion of wavelength multiplexed light, optical elements are expected to be employed that have, for example, a monitoring function of monitoring the optical power in each wavelength after the wavelength dispersion and a switch function of switching the optical path for each wavelength.

In such an optical communication system, wavelength intervals in the wavelength multiplexed light are predetermined according to the ITU grid. However, when predetermined processing is to be performed inside a unit for each wavelength after the wavelength dispersion of wavelength multiplexed light, a larger angular dispersion per one channel interval is more preferable in many cases.

This is because when an angular dispersion per one channel interval is larger, wavelength-directional arrangement intervals can be expanded more for optical elements that are arranged for the individual wavelengths and receive light signals dispersed by the diffraction grating so as to perform the above-mentioned predetermined processing, This simplifies the mounting. An example of such an optical element is a MEMS (Micro Electro Mechanical Systems) mirror array arranged for each wavelength, and the like.

### SUMMARY

It is an aspect of the embodiments discussed herein to provide an optical device including a diffraction grating having first and second planes; and first and second reflecting planes located on a second plane side of the diffraction grating, wherein light input to the first plane of the diffraction grating is diffracted, and then an optical path of the diffracted light is re-input to the second plane of the diffraction grating newly via the first and the second reflecting planes.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an exemplary configuration of an optical device.

FIG. 2 illustrates an optical device employing one reflection mirror.

FIG. 3 illustrates an optical path of an optical device focused on one wavelength.

FIG. 4 illustrates an optical device employing two reflection mirrors.

FIG. 5 illustrates an optical path of an optical device in a case that attention is focused on one wavelength.

FIG. 6 illustrates an optical path of an optical device in a case of wavelength multiplexing.

FIG. 7 illustrates an exemplary optical device employing a prism.

FIG. 8 illustrates an exemplary optical device employing a concave mirror.

FIG. 9 illustrates an optical path of zero-th light.

FIG. 10 illustrates an occurrence of cross talk.

FIG. 11 illustrates an optical path of zero-th light.

FIG. 12 illustrates an optical path of wavelength dispersion light (diffracted light).

FIG. 13 illustrates a case when an emitting angle of a zero-th light is smaller than an emitting angle of a diffracted light signal having a minimum wavelength.

FIG. 14 illustrates a case when an emitting angle of a zero-th light is greater than an emitting angle of a diffracted light signal having a maximum wavelength.

FIG. 15 illustrates an exemplary WSS.

FIG. 16 illustrates an exemplary WSS.

FIG. 17 illustrates an exemplary WSS that employs an optical device.

FIG. 18 illustrates an exemplary WSS that employs an optical device.

FIG. 19 illustrates a case when cross talk occurs in a WSS.

FIG. 20 illustrates a case when cross talk occurs in a WSS.

FIG. 21 illustrates a case when an optical path of zero-th light goes outside a MEMS mirror.

FIG. 22 illustrates a WSS having a light shielding mask.

FIG. 23 illustrates a transmission type diffraction grating.

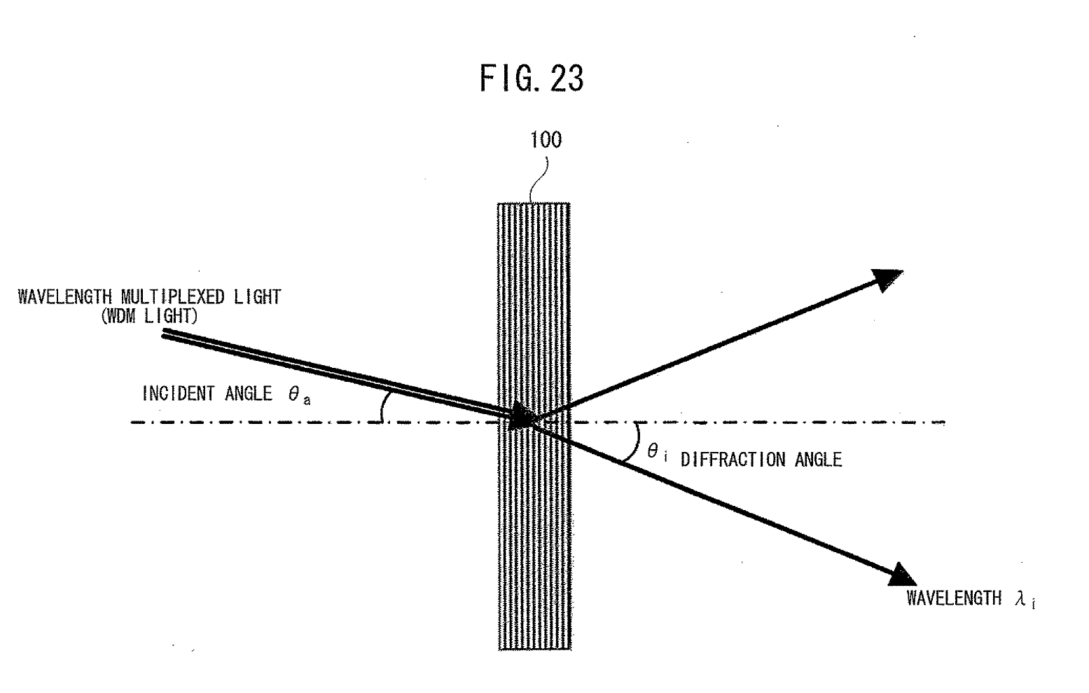

### DETAILED DESCRIPTION OF THE EMBODIMENTS

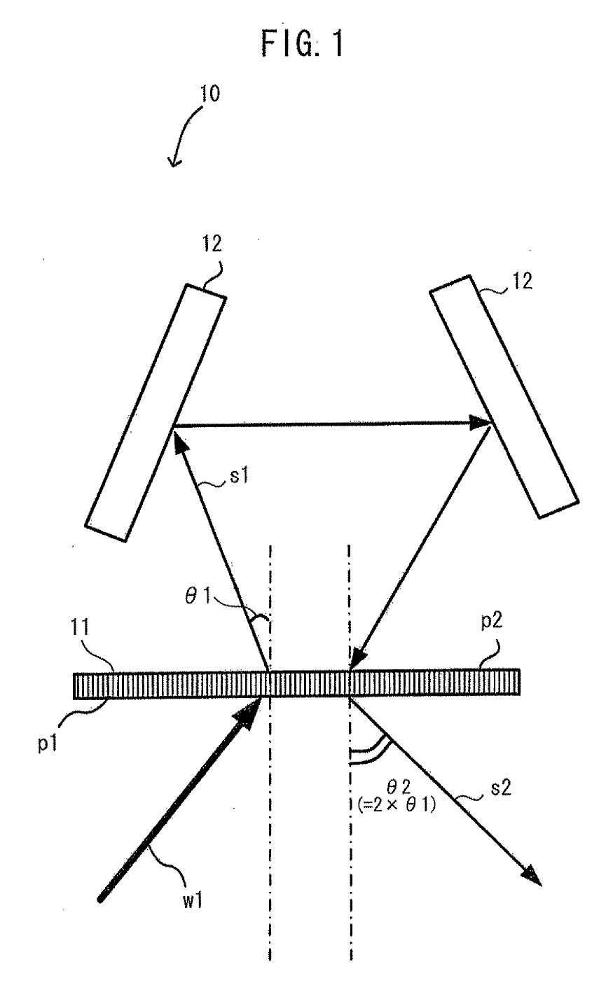

FIG. 1 illustrates an exemplary configuration of an optical device. The optical device 10 includes a diffraction grating 11 and a light deflection unit 12 and that may have a wavelength dispersion function.

The diffraction grating 11 is a transmission type diffraction grating in which a light beam of wavelength multiplexed light (WDM light) w1 enters a first plane (plane p1) and then first wavelength dispersion light (diffracted light) s1 generated by the wavelength dispersion in the first diffraction of the wavelength multiplexed light w1 emits from a second plane (plane p2) so that the wavelength multiplexed light w1 is separated into individual wavelengths. The light deflection unit 12 is an optical unit containing one or a plurality of optical deflectors that are arranged on the plane p2 side of the diffraction grating 11 and that can change the angle of wavelength dispersion light s1 emitted as a light beam from the plane p2 so as to cause the light beam to re-enter the plane p2 and thereby change arbitrarily the incident angle and the incident position at that time.

The second wavelength dispersion light s2 generated when the first wavelength dispersion light s1 enters the plane p2 via the light deflection unit 12 and then diffracted again by the diffraction grating 11 is emitted from the plane p1 with an angular dispersion greater than that obtained when the first wavelength dispersion light s1 is diffracted by the second plane. The first wavelength dispersion light s1 indicates diffracted light of individual wavelengths emitted from the second plane of the diffraction grating 11 after the wavelength multiplexed light w1 transmits the diffraction grating 11 once. The second wavelength dispersion light s2 indicates diffracted light of individual wavelengths emitted finally from the first plane of the diffraction grating 11 after the wavelength multiplexed light w1 transmits the diffraction grating 11 twice.

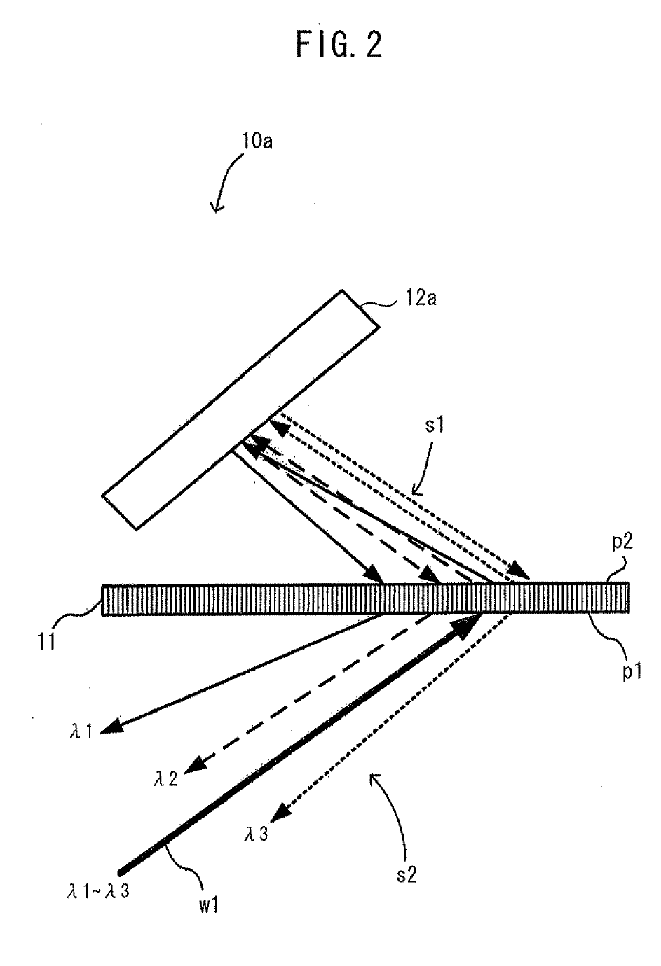

An exemplary configuration and the arrangement position of the light deflection unit 12 are described below. The light deflection unit 12 includes a reflection mirror in many cases, and hence referred to as a reflection mirror, hereinafter. FIG. 2 illustrates an exemplary optical device employing one reflection mirror.

The optical device 10a includes one reflection mirror 12a and a diffraction grating 11. The wavelength multiplexed light w1 is a light signal generated by multiplexing, for example, mutually different wavelengths λ1 to λ3. The wavelength multiplexed light w1 enters the plane p1 of the diffraction grating, then undergoes wavelength dispersion into individual wavelengths λ1 to λ3, and then is emitted from the plane p2 in the form of the first wavelength dispersion light s1.

The reflection mirror 12a reflects the first wavelength dispersion light s1 so as to cause the light to repenter the plane p2. The diffraction grating 1, the second wavelength dispersion light s2 of individual wavelengths λ1 to λ3 is emitted from the plane p1 with an angular dispersion greater than that obtained in the first diffraction.

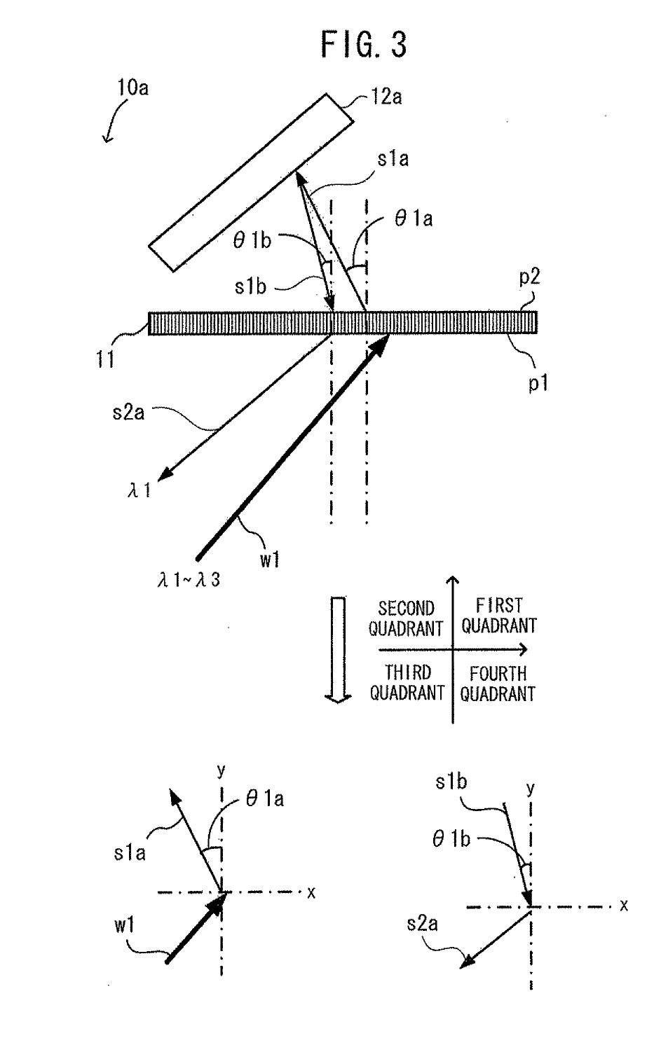

FIG. 3 illustrates an optical path of the optical device 10a focused on one wavelength. In the optical device 10a, the emitting angle (diffraction angle) of the first wavelength dispersion light that is generated by the wavelength dispersion in the first transmission through the diffraction grating 11 and that is emitted from the plane p2 of the diffraction grating 11 and the incident angle of the first wavelength dispersion light at the time of reentrance into the plane p2 are in the same direction with each other relative to the perpendicular line to the first plane of the diffraction grating 11.

For example, when focused on the wavelength λ1, the emitting angle (diffraction angle) θ1a of the first wavelength dispersion light s1a of wavelength λ1 emitted from the plane p2 and the incident angle θ1b of the first wavelength dispersion light s1b of wavelength λ1 at the time of reentrance into the plane p2 are inclined in the same direction relative to the perpendicular line to the first plane.

Further, in the optical device 10a having this configuration, the emitting angle (diffraction angle) direction of the second wavelength dispersion light s2a is in the same direction as the incident angle direction of the wavelength multiplexed light w1. Thus, application of the optical device 10a is effective when the mounting positions of an optical element that accepts wavelength multiplexed light and an optical element that accepts wavelength dispersion light are close to each other.

The positions of the individual optical paths are described below. The perpendicular line to the first plane is adopted as the y-axis. The direction perpendicular to the direction of the diffraction grating grooves is adopted as the x-axis. The wavelength multiplexed light w1 enters the plane p1 from the third quadrant. The first wavelength dispersion light s1a is emitted in the second quadrant toward the reflection mirror 12a.

The first wavelength dispersion light s1b reflected by the reflection mirror 12a enters the plane p2 from the second quadrant, and then the second wavelength dispersion light s2a is emitted in the third quadrant toward the plane p1.

The coordinate region whose x-axis is positive and whose y-axis is positive is the first quadrant. The coordinate region whose x-axis is negative and whose y-axis is positive is the second quadrant. The coordinate region whose x-axis is negative and whose y-axis is negative is the third quadrant. The coordinate region whose x-axis is positive and whose y-axis is negative is the fourth quadrant.

The positions of the optical paths for various modes (a) to (d) of arrangement of the reflection mirror 12a are described below in terms of the coordinate quadrant.

(a) When the reflection mirror 12a is arranged in the first quadrant, the incident light path of the wavelength multiplexed light w1 is located in the fourth quadrant, the optical path of the first wavelength dispersion light emitted from the plane p2 is located in the first quadrant, the first wavelength dispersion light that is reflected by the reflection mirror 12a and then re-enters the plane p2 is located in the first quadrant, and the emitted light path of the second wavelength dispersion light is located in the fourth quadrant.

(b) When the reflection mirror 12a is arranged in the second quadrant, as illustrated in FIG. 3, the incident light path of the wavelength multiplexed light w1 is located in the third quadrant, the optical path of the first wavelength dispersion light emitted from the plane p2 is located in the second quadrant, the first wavelength dispersion light that is reflected by the reflection mirror 12a and then re-enters the plane p2 is located in the second quadrant, and the emitted light path of the second wavelength dispersion light is located in the third quadrant.

(c) When the reflection mirror 12a is arranged in the third quadrant, the incident light path of the wavelength multiplexed light w1 is located in the second quadrant, the optical path of the first wavelength dispersion light emitted from the plane p2 is located in the third quadrant, the first wavelength dispersion light that is reflected by the reflection mirror 12a and then re-enters the plane p2 is located in the third quadrant, and the emitted light path of the second wavelength dispersion light is located in the second quadrant.

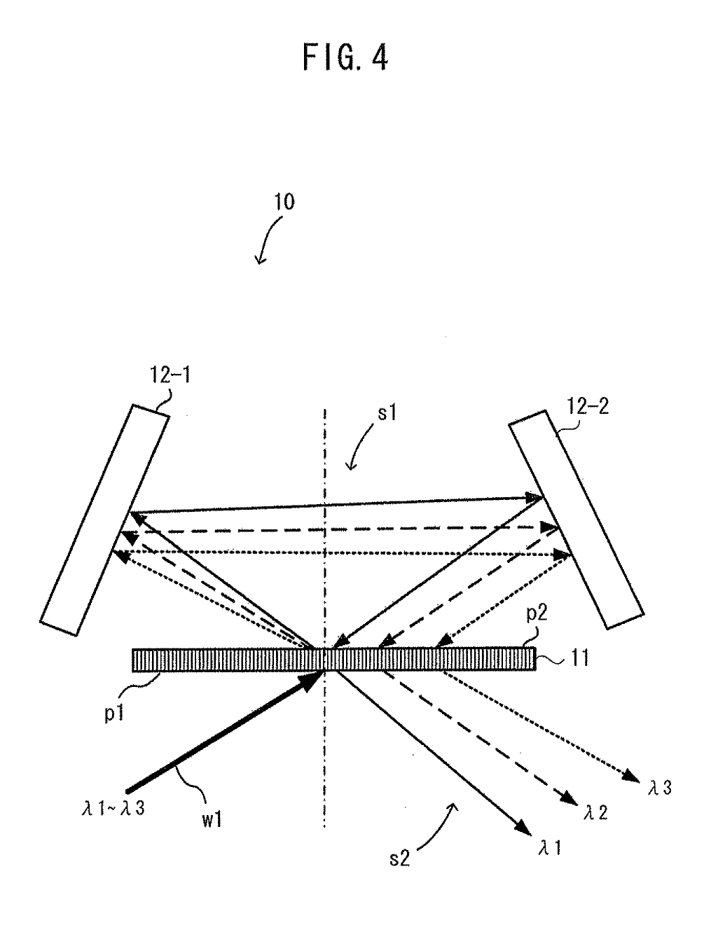

(d) When the reflection mirror 12a is arranged in the fourth quadrant, the incident light path of the wavelength multiplexed light w1 is located in the first quadrant, the optical path of the first wavelength dispersion light emitted from the plane p2 is located in the fourth quadrant, the first wavelength dispersion light that is reflected by the reflection mirror 12a and then re-enters the plane p2 is located in the fourth quadrant, and the emitted light path of the second wavelength dispersion light is located in the first quadrant. FIG. 4 illustrates an optical device employing two reflection mirrors. The optical device 10 includes two reflection mirrors 12-1 and 12-2 and a diffraction grating 11.

The wavelength multiplexed light w1 generated by multiplexing mutually different wavelengths λ1 to λ3 enters the plane p1 of the diffraction grating. The wavelength multiplexed light w1 undergoes wavelength dispersion into individual wavelengths λ1 to λ3, and then is emitted from the plane p2 in the form of the first wavelength dispersion light s1. The reflection mirror 12-1 reflects toward the reflection mirror 12-2 the first wavelength dispersion light s1 emitted from the plane p2, while the reflection mirror 12-2 causes the first wavelength dispersion light s1 reflected by the reflection mirror 12-1 to re-enter the diffraction grating 11. The diffraction grating 11, the second wavelength dispersion light s2 of individual wavelengths λ1 to λ3 is emitted from the plane p1 with an angular dispersion greater than that obtained in the first diffraction.

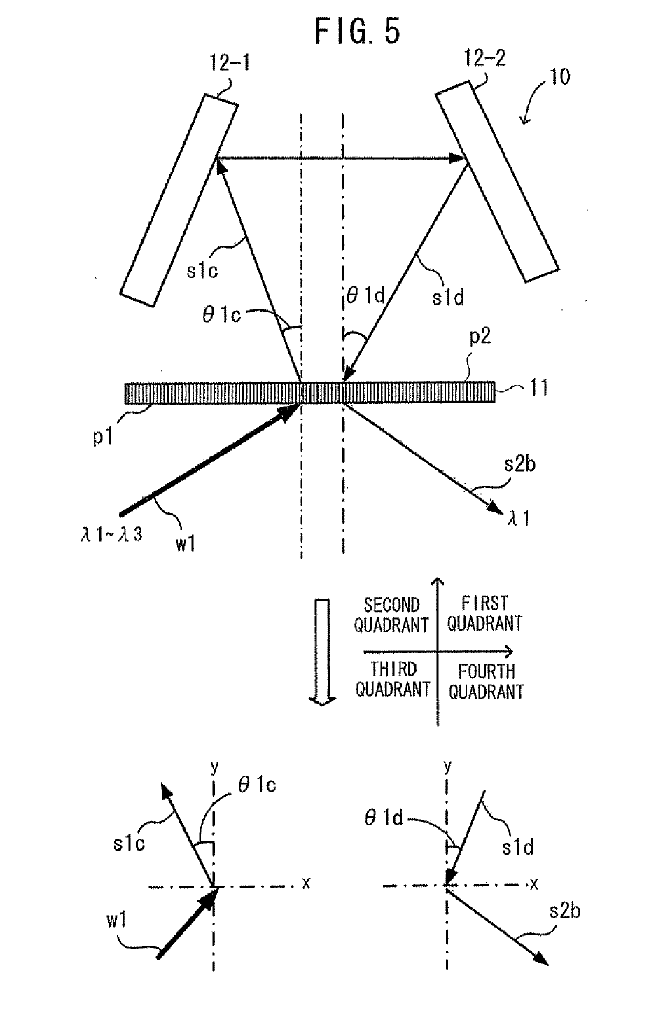

FIG. 5 illustrates an optical path of the optical device 10 focused on one wavelength. In the optical device 10, the emitting angle (diffraction angle) of the first wavelength dispersion light that is generated by the wavelength dispersion in the first transmission through the diffraction grating 11 and that is emitted from the plane p2 and then goes to the reflection mirror 12-1 and the incident angle of the first wavelength dispersion light at the time of reentrance into the plane p2 via the reflection mirror 12-2 are in opposite directions to each other relative to the perpendicular line to the first plane of the diffraction grating 11. For example, when attention is focused on the wavelength λ1, the emitting angle (diffraction angle) θ1c of the first wavelength dispersion light s1c of wavelength λ1 generated by the wavelength dispersion emitted from the plane p2 and the incident angle θ1d of the first wavelength dispersion light s1d of wavelength λ1 at the time of reentrance into the plane p2 are in opposite directions to each other relative to the perpendicular line.

Further, in the optical device 10 having this configuration, the emitting angle direction of the second wavelength dispersion light s2b is in an opposite direction to the incident angle direction of the wavelength multiplexed light w1. Accordingly, the optical element that accepts the wavelength multiplexed light and the optical element that accepts the wavelength dispersion light can be mounted and arranged with a sufficient spacing (in practice, the optical device 10 illustrated in FIGS. 4 and 5 has various advantages over the optical device 10a illustrated in FIGS. 2 and 3 in terms of the mounting and the optical coupling efficiency. Thus, the following description is given mainly for the optical device 10 employing two reflection mirrors.)

The positions of the individual optical paths are described below. The perpendicular line to the first plane is adopted as the y-axis. The direction perpendicular to the direction of the diffraction grating grooves is adopted as the x-axis. Then, in a mode of the diffraction grating that can be arranged in various manners, the wavelength multiplexed light w1 is assumed to enter the plane p1 from the third quadrant. Under this assumption, the first wavelength dispersion light s1c is emitted toward the reflection mirror 12-1 in the second quadrant. The first wavelength dispersion light s1d reflected by the reflection mirror 12-2 enters the plane p2 from the first quadrant, and then the second wavelength dispersion light s2b is emitted in the fourth quadrant toward the plane p1.

The positions of the optical paths for various modes (e) to (h) of arrangement of the reflection mirrors 12-1 and 12-2 are described below in terms of the coordinate quadrant:

(e) When the reflection mirror 12-1 is arranged in the first quadrant and the reflection mirror 12-2 may be arranged in the second quadrant, the incident light path of the wavelength multiplexed light w1 is located in the fourth quadrant, the optical path of the first wavelength dispersion light that is emitted from the plane p2 toward the reflection mirror 12-1 is located in the first quadrant, the first wavelength dispersion light that is reflected by the reflection mirror 12-2 and then re-enters the plane p2 is located in the second quadrant, and the emitted light path of the second wavelength dispersion light is located in the third quadrant.

(f) When the reflection mirror 12-2 is arranged in the first quadrant and the reflection mirror 12-1 is arranged in the second quadrant, as illustrated in FIG. 5, the incident light path of the wavelength multiplexed light w1 is located in the third quadrant, the optical path of the first wavelength dispersion light that is emitted from the plane p2 toward the reflection mirror 12-1 is located in the second quadrant, the first wavelength dispersion light that is reflected by the reflection mirror 12-2 and then re-enters the plane p2 is located in the first quadrant, and the emitted light path of the second wavelength dispersion light is located in the fourth quadrant.

(g) When the reflection mirror 12-1 is arranged in the third quadrant and the reflection mirror 12-2 is arranged in the fourth quadrant, the incident light path of the wavelength multiplexed light w1 is located in the second quadrant, the optical path of the first wavelength dispersion light that is emitted from the plane p2 toward the reflection mirror 12-1 is located in the third quadrant, the first wavelength dispersion light that is reflected by the reflection mirror 12-2 and then re-enters the plane p2 is located in the fourth quadrant, and the emitted light path of the second wavelength dispersion light is located in the first quadrant.

(h) When the reflection mirror 12-2 is arranged in the third quadrant and the reflection mirror 12-1 is arranged in the fourth quadrant, the incident light path of the wavelength multiplexed light w1 is located in the first quadrant, the optical path of the first wavelength dispersion light that is emitted from the plane p2 toward the reflection mirror 12-1 is located in the fourth quadrant, the first wavelength dispersion light that is reflected by the reflection mirror 12-2 and then re-enters the plane p2 is located in the third quadrant, and the emitted light path of the second wavelength dispersion light is located in the second quadrant.

As described above, in the optical device 10, one diffraction grating 11 and two reflection mirrors 12-1 and 12-2 are provided. The first wavelength dispersion light s1 is reflected twice by the reflection mirrors 12-1 and 12-2 so as to re-enter the diffraction grating 11. By virtue of this, the angular dispersion of the diffracted light obtained finally is enhanced in comparison with that of the diffracted light obtained by single diffraction in the configuration employing a single diffraction grating. Accordingly, the use of remarkably inexpensive reflection mirrors 12-1 and 12-2 realizes the enhancement of angular dispersion, and hence can reduce the cost (remarkable cost reduction can be achieved, for example, in comparison with conventional systems.

On the other hand, in Equation (1), the condition in which θi=θa (the incident angle onto the diffraction grating is equal to the diffraction angle) is satisfied for a particular wavelength λi is referred to as the Bragg condition. In general, in diffraction gratings, the diffraction efficiency (the ratio between the incident light optical power onto the diffraction grating and the diffracted light optical power of a predetermined degree) becomes the maximum (the light loss becomes the minimum) in this condition.

In the wavelength dispersion processing that employs the configuration of the optical device 10a, in a case that other optical elements (optical elements to be arranged on the light incidence side relative to the diffraction grating and optical elements for processing (monitoring, switching, and the like) the light emitted from the diffraction grating) are to be arranged in the periphery of the diffraction grating, when the deviation between the incident angle onto the diffraction grating and the diffraction angle of the diffracted light (the angle difference between the incident angle and the diffraction angle) is increased, the optical elements on the incidence side and the optical elements on the emission side can be arranged with a certain amount of spacing. Nevertheless, in this case, the diffraction efficiency is degraded.

In contrast, in the configuration of the optical device 10, the incident angle of the wavelength multiplexed light w1 onto the diffraction grating 11 and the emitting angle of the second wavelength dispersion light s2 are automatically in opposite directions relative to the perpendicular line to the first plane. Thus, an advantage may be obtained that arrangement of other optical elements is easy (that is, optical elements for input processing for the wavelength multiplexed light w1 and optical elements for output processing for the diffracted light signal emitted from the diffraction grating 11 can be arranged with sufficient spacing. Accordingly, without degradation in the diffraction efficiency, such optical elements can easily be mounted and arranged with sufficient spacing.

Further, according to a configuration of the optical device 10, both the wavelength multiplexed light w1 and the second wavelength dispersion light s2 are located on the same plane side (the plane p1 side) of the diffraction grating 11. Thus, the diffraction grating 11 and the reflection mirrors 12-1 and 12-2 can be arranged without a problem of interference between these beams, and hence the size can be minimized.

Further, in the optical device 10, the reflection mirrors 12-1 and 12-2 are provided only on one plane side of the diffraction grating 11. Then, when the angles of the two reflection mirrors are adjusted, the wavelength dispersion light can be caused to be incident at an arbitrary position of the diffracting plane of the diffraction grating 11 at an arbitrary angle. Thus, the position of the wavelength dispersion light on the diffracting plane can be made approximately agreeing with the position of the wavelength multiplexed light. Thus, in comparison with conventional systems in which reflecting planes are provided in the two faces of the diffraction grating, the necessary effective diameter is not increased, and hence the effective diameter of the diffraction grating can be reduced.

The above-mentioned description has been given for the beam path in the direction of causing wavelength dispersion. However, in the optical device 10, when the beam progresses in the reverse direction, the function of wavelength multiplexing is also achieved.

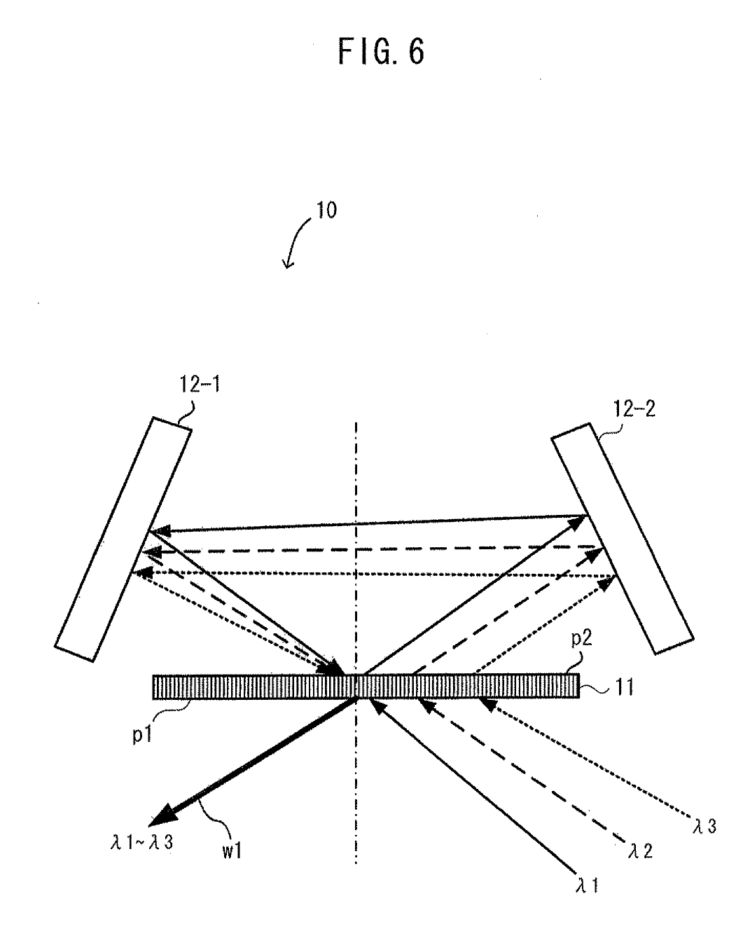

FIG. 6 illustrates an optical path of the optical device 10 in a case of wavelength multiplexing. FIG. 6 may be obtained by reversing the direction of the arrow indicating the direction of the optical path of the optical device 10 shown in FIG. 4.

The plane p1 of the diffraction grating 11 is a plane where a plurality of light beams of mutually different wavelengths enter at the first time. The plane p2 is a plane from which the diffracted light beams obtained by the first diffraction are emitted. The reflection mirrors 12-1 and 12-2 deflect the diffracted light so as to cause the light to re-enter the plane p2. When the diffracted light re-enters the plane p2 via the reflection mirrors 12-1 and 12-2, one wavelength multiplexed light beam w1 having undergone wavelength multiplexing is emitted from the plane p1 of the diffraction grating 11.

The optical path is described below. The individual light signals of wavelengths λ1 to λ3 enter the plane p1 of the diffraction grating 11, and are diffracted by the diffraction grating 11. The individual diffracted light beams of wavelengths λ1 to λ3 emitted from the plane p2 go to the reflection mirror 12-2.

The reflection mirror 12-2 reflects the individual diffracted light beams of wavelengths λ1 to λ3. The reflection mirror 12-1 causes the individual diffracted light beams reflected by the reflection mirror 12-2 to enter the plane p2 of the diffraction grating 11. As a result, a wavelength multiplexed light beam w1 in which wavelengths λ1 to λ3 are multiplexed is emitted from the plane p1 of the diffraction grating 11

A modification of the optical device 10 may include a prism or a concave mirror in place of the reflection mirrors 12-1 and 12-2.

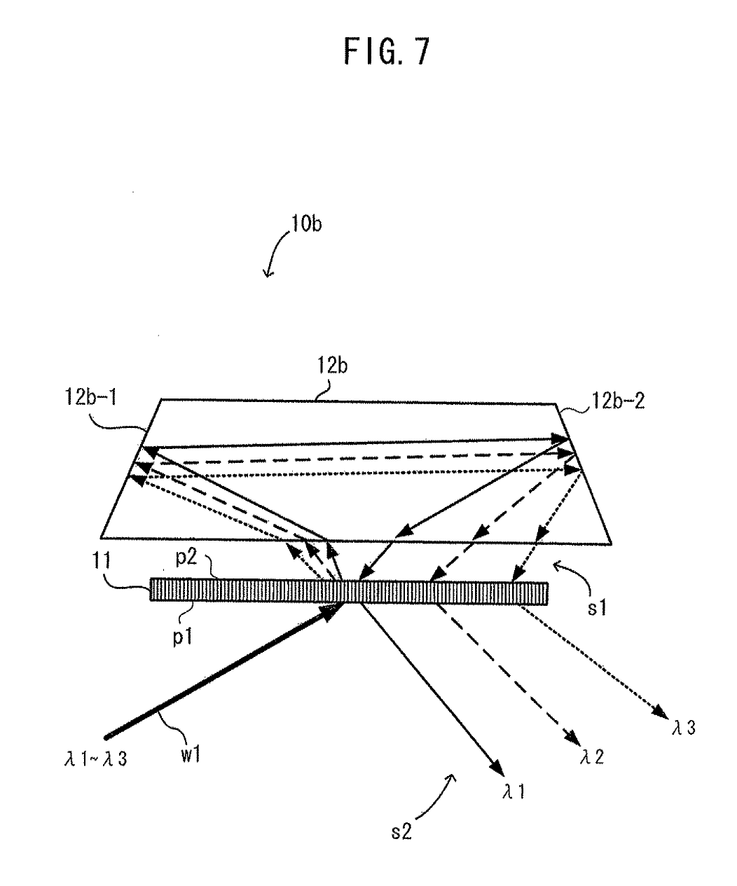

FIG. 7 is a diagram illustrating an exemplary optical device employing a prism. An optical device 10b includes a prism 12b and a diffraction grating 11. The optical device 10b is constructed by adopting the prism 12b in place of the reflection mirrors 12-1 and 12-2, and has the same function as the optical device 10.

The wavelength multiplexed light w1 is separated into individual wavelengths by the diffraction grating 11, and then first wavelength dispersion light s1 is emitted from the plane p2. The first reflecting plane (reflecting plane 12b-1) of the prism 12b reflects the first wavelength dispersion light s1 emitted from the plane p2, toward the second reflecting plane (reflecting plane 12b-2) of the prism 12b. The reflecting plane 12b-2 causes the first wavelength dispersion light s1 reflected by the reflecting plane 12b-1 to re-enter the diffraction grating 11. The diffraction grating 11, second wavelength dispersion light s2 that has an angular dispersion greater than the value obtained in the first diffraction and that has undergone wavelength dispersion into wavelengths λ1 to λ3 is emitted from the plane p1.

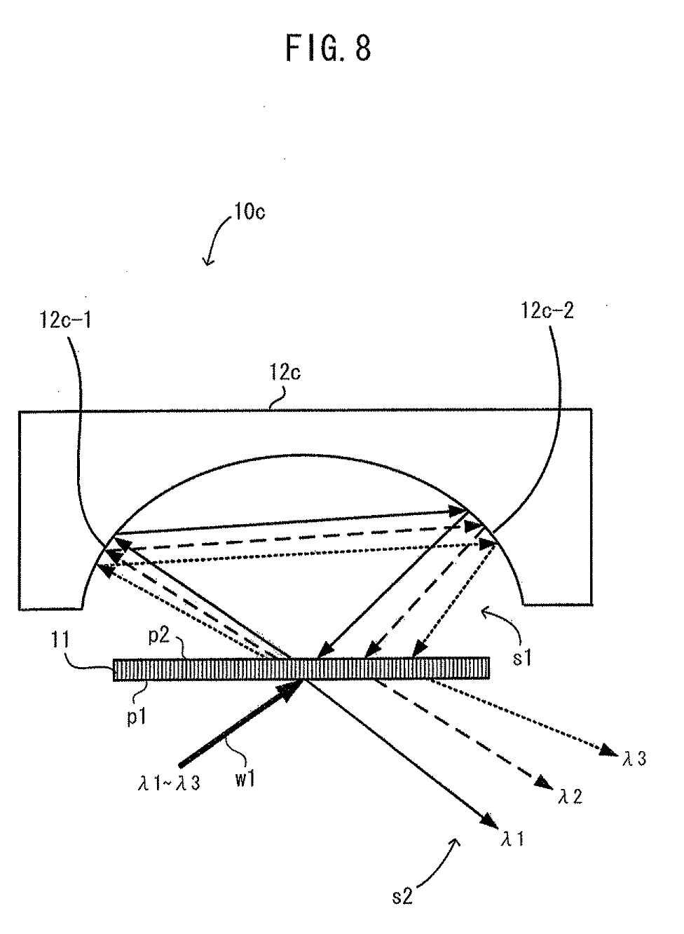

FIG. 8 is a diagram illustrating an exemplary optical device employing a concave mirror. An optical device 10c includes a concave mirror 12c and a diffraction grating 11. The optical device 10c is constructed by adopting the concave mirror 12c in place of the reflection mirrors 12-1 and 12-2, and has the same function as the optical device 10.

The wavelength multiplexed light w1 is separated into individual wavelengths by the diffraction grating 11, and then first wavelength dispersion light s1 is emitted from the plane p2. A first reflecting surface (reflecting surface 12c-1) of the concave mirror 12c reflects toward a second reflecting surface (reflecting surface 12c-2) the first wavelength dispersion light s1 emitted from the plane p2, while the reflecting surface 12c-2 causes the first wavelength dispersion light s1 reflected by the reflecting surface 12c-1 to re-enter the diffraction grating 11. The diffraction grating 11, second wavelength dispersion light s2 that has an angular dispersion greater than the value obtained in the first diffraction and that has undergone wavelength dispersion into wavelengths λ1 to λ3 is emitted from the plane p1.

The phenomenon of cross talk generated between the second wavelength dispersion light (the diffracted light signal, hereinafter) and the non-diffracted light (zero-th light). The zero-th light indicates a light beam which is not diffracted when entering a transmission type diffraction grating and hence in which the incident angle of the incident light is equal to the emitting angle of the emitted light (this indicates a light beam transmitted intact through the transmission type diffraction grating. In a case of a reflection type diffraction grating, this indicates a light beam advancing in the direction of ordinary reflection).

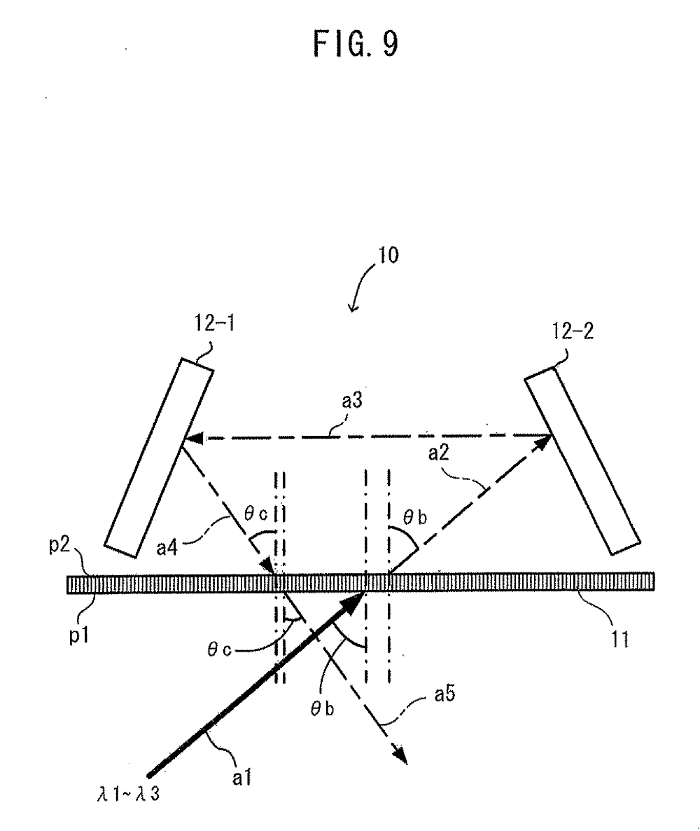

FIG. 9 is a diagram illustrating the optical path of the zero-th light. This figure shows the optical path of the zero-th light in the optical device 10. The wavelength multiplexed light w1 enters the plane p1 of the diffraction grating 11 (arrow a1). The zero-th light of the wavelength multiplexed light w1 is transmitted intact through the diffraction grating 11 (advances at an emitting angle θb equal to the incident angle θb formed by arrow a1), and then emitted from the plane p2 (arrow a2).

The reflection mirror 12-2 reflects toward the reflection mirror 12-1 (arrow a3) the zero-th light emitted from the plane p2. The reflection mirror 12-1 causes the light to re-enter the diffraction grating 11 from the plane p2 (arrow a4). The zero-th light at that time advances straight at an emitting angle θc equal to the incident angle (the incident angle θc formed by arrow a4), and then is emitted from the plane p1 (arrow a5).

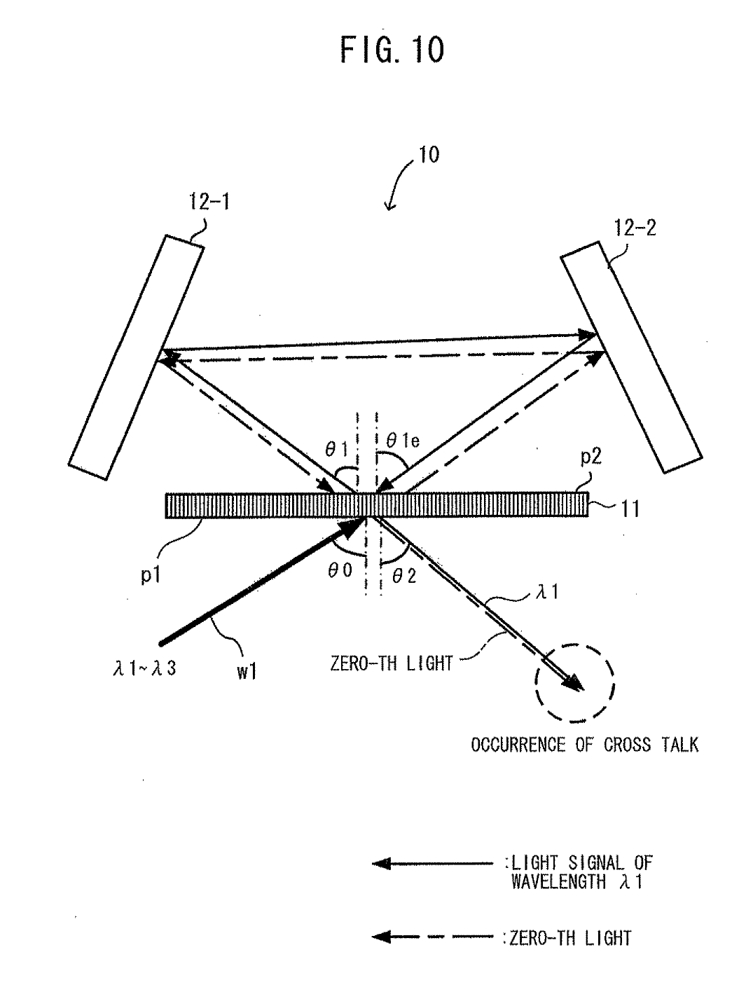

FIG. 10 is a diagram illustrating a situation of occurrence of cross talk. This figure shows a case when cross talk occurs for a light beam of wavelength λ1. In the optical device 10, it is assumed that wavelength dispersion of the wavelength multiplexed light w1 is performed according to the flow of light beams described above in FIG. 4 (for simplicity of understanding, the optical paths of the light beam of wavelength λ1 and the zero-th light are solely shown).

Here, for the light signal of wavelength λ1, the Bragg condition is satisfied in the first diffraction (the incident angle θ0 of the wavelength multiplexed light w1 onto the plane p1 is equal to the emitting angle θ1 of the diffracted light of wavelength λ1 emitted from the plane p2 in the first diffraction (θ0=θ1)). Further, when the Bragg condition is satisfied also in the second diffraction (the incident angle θ1e of the diffracted light that is reflected by the reflection mirror 12-2 and then enters the plane p2 is equal to the emitting angle θ2 of the final diffracted light signal of wavelength λ1 emitted from the plane p1 (θ1e=θ2), the emitting angle of the diffracted light signal of wavelength λ1 becomes equal to the emitting angle of the zero-th light (the two light beams have the emitting angle of θ2).

That is, when the above-mentioned two Bragg conditions are satisfied, the incident angle θ0 of the first incidence onto the diffraction grating 11 becomes equal to the incident angle θ1e of the second incidence from the reflection mirror 12-2 onto the diffraction grating 11 (in conclusion, when the two Bragg conditions are satisfied, θ0=θ1=θ1e=θ2). Thus, the emitting angle of the diffracted light signal which is the final diffracted light of wavelength λ1 becomes equal to the emitting angle of the zero-th light.

As such, when a particular adopted wavelength and the zero-th light have the same emitting angle, cross talk occurs because the zero-th light has all wavelength components (in this example, cross talk occurs in the light signal of wavelength λ1). This causes degradation in communication quality.

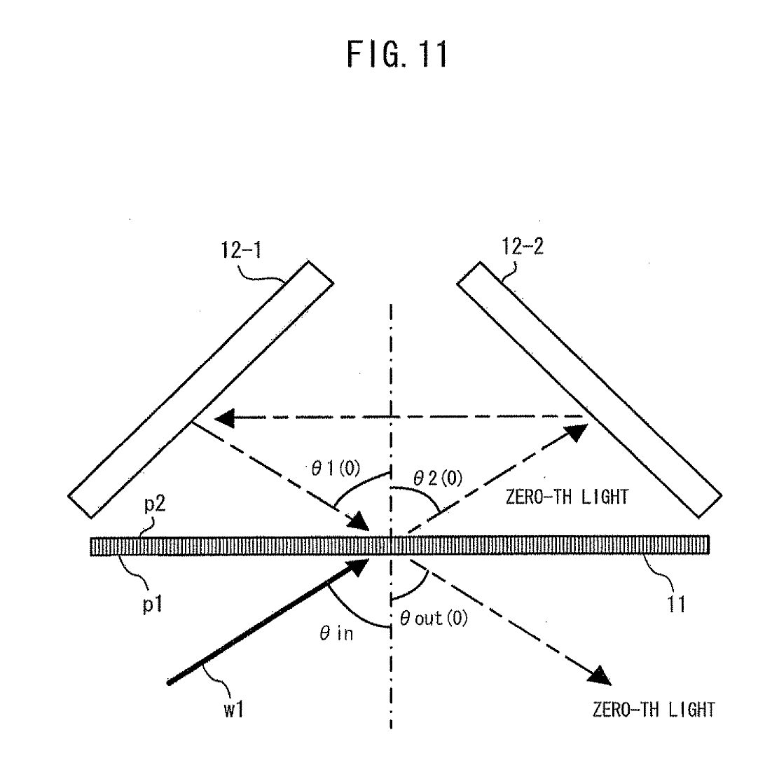

The feature of suppressing cross talk in the optical device 10 is described below, FIG. 11 is a diagram illustrating the optical path of the zero-th light. This figure shows the optical path of the zero-th light in the optical device 10. The incident angle of the wavelength multiplexed light w1 at the first incidence onto the plane p1 of the diffraction grating 11 is denoted by θin. The angle of the zero-th light emitted from the plane p2 toward the reflection mirror 12-2 is denoted by θ2(0). The angle of the zero-th light that enters the plane p2 from the reflection mirror 12-1 is denoted by θ1(0). The emitting angle of the final zero-th light from the plane p1 is denoted by θout(0). Then, symbol A is defined as the difference between the angles θ1(0) and θ2(0) as shown in the following Equation (2).

A=θ1(0)−θ2(0) (2)

The relation of θout(0) to θin may be expressed by the following Equation (3).

θout(0)=θin+A (3)

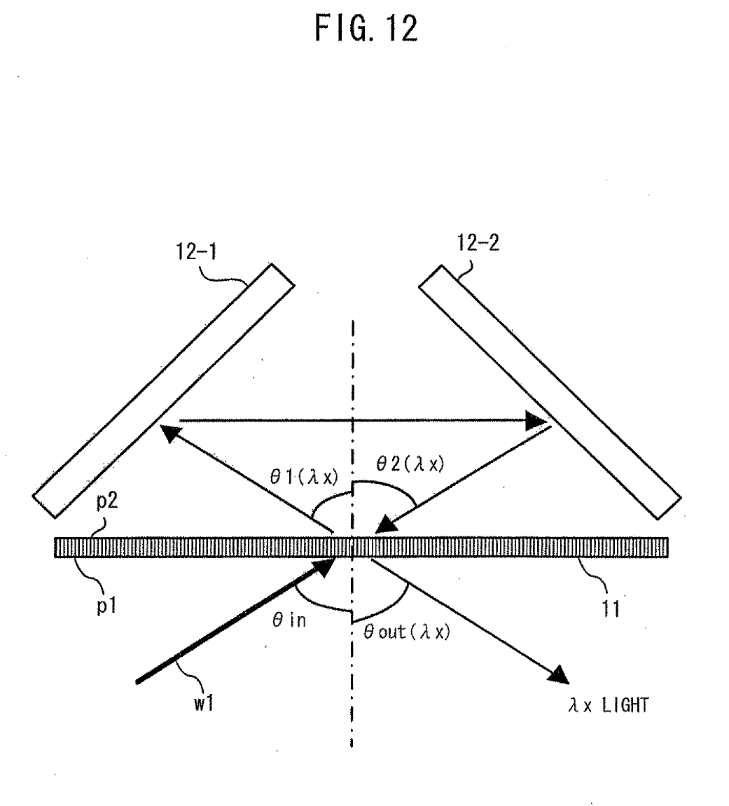

FIG. 12 is a diagram illustrating the optical path of diffracted light of a particular wavelength λx. The incident angle of the wavelength multiplexed light w1 at the first incidence onto the plane p1 of the diffraction grating 11 is denoted by θin. The emitting angle of the λx light emitted from the plane p2 toward the reflection mirror 12-1 is denoted by θ1(λx). The incident angle of the λx light that enters the plane p2 from the reflection mirror 12-2 is denoted by θ2(λx). The emitting angle of the final λx light from the plane p1 is denoted by θout(λx).

The emitting angle θ1(λx) of the λx light from the plane p2 of the diffraction grating 11 to the reflection mirror 12-1 may be expressed by the following Equation (4). Here, d indicates the grid period of the diffraction grating 11, and n indicates the degree of diffraction.

θ1(λx)=arcsin [(n·λx/d)−sin(θin)] (4)

The incident angle θ2(λx) of the λx light that enters the plane p2 of the diffraction grating 11 from the reflection mirror 12-2 may be expressed by the following Equation (5).

θ2(λx)=θ1(λx)−A (5)

On the other hand, the emitting angle θout(λx) of the final diffracted light signal of λx from the plane p1 of the diffraction grating 11 may be expressed by the following Equation (6).

θout(λx)=arcsin [(n·λx/d)−sin(θ2(λx))] (6)

The minimum wavelength of the adopted wavelength in the optical device 10 is denoted by λa, while the maximum wavelength is denoted by λb. Then, for the emitting angle θout(λa) of the diffracted tight signal of the minimum wavelength λa and the emitting angle θout(λb) of the diffracted light signal of the maximum wavelength λb, when the emitting angle θout(0) of the zero-th light does not fall within the range from θout(λa) to θout(λb), occurrence of cross talk is suppressed.

Namely, it is sufficient that any one of the following Equations (7a) and (7b) is satisfied (each term on the right-hand side of the inequality sign is equal to θout(0) according to Equation (3)).

θout(λa)>θin+A (7a)

θout(λb)<θin+A (7b)

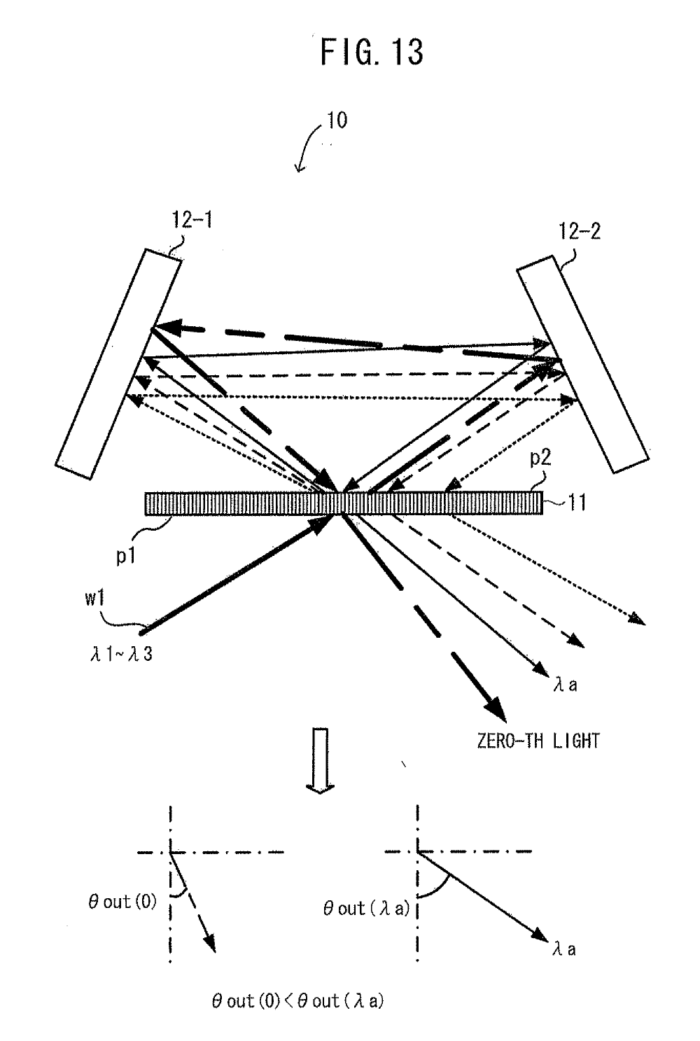

FIG. 13 is a diagram illustrating a case when the emitting angle of the zero-th light is smaller than the emitting angle of the diffracted light signal having the minimum wavelength λa. This figure shows the optical path in a case that Equation (7a) is satisfied. The emitting angle θout(0) of the zero-th light is smaller than the emitting angle θout(λa) of the diffracted light signal of the minimum wavelength λa; Thus, their optical paths do not agree with each other, and hence cross talk does not occur.

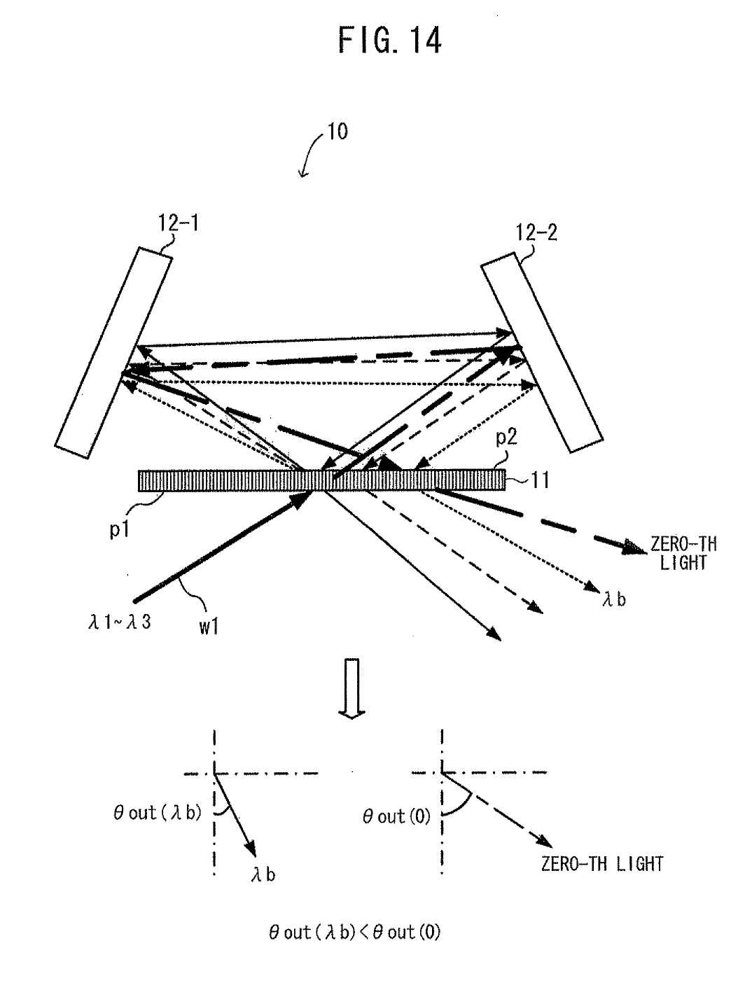

FIG. 14 is a diagram illustrating a case when the emitting angle of the zero-th light is greater than the emitting angle of the diffracted light signal having the maximum wavelength λb. This figure shows the optical path in a case that Equation (7b) is satisfied. The emitting angle θout(0) of the zero-th light is greater than the emitting angle θout(λb) of the diffracted light signal of the maximum wavelength λb. Thus, their optical paths do not agree with each other, and hence cross talk does not occur.

Here, when λx in Equation (6) is substituted by λa, the left-hand side term θout(λa) of Equation (7a) is rewritten into

θout(λa)=arcsin [(n·λa/d)−sin(θ2(λa))] (6a)

Further, from Equation (5), θ2(λa) in Equation (6a) is written as

θ2(λa)=θ1(λa)−A (5a)

Thus, when Equation (5a) is substituted into Equation (6a),

θout(λa)=arcsin [(n·λa/d)−sin(ν1(λa)−A)] (8)

may be obtained. Further, θ1 (λa) in Equation (8) may be obtained from Equation (4).

Thus, the emitting angle θout(λa) of the diffracted light signal of the minimum wavelength λa is calculated from the Equation described above when the various parameters are given that consist of the grid period d, the degree n of diffraction, the wavelength λa, the angle difference A between the emitting angle of the zero-th light from the plane p2 and the incident angle onto the plane p2, and the incident angle θin of the wavelength multiplexed light w1. The left-hand side term θout(λb) of Equation (7b) is similarly calculated when λx is substituted by the maximum wavelength λb.

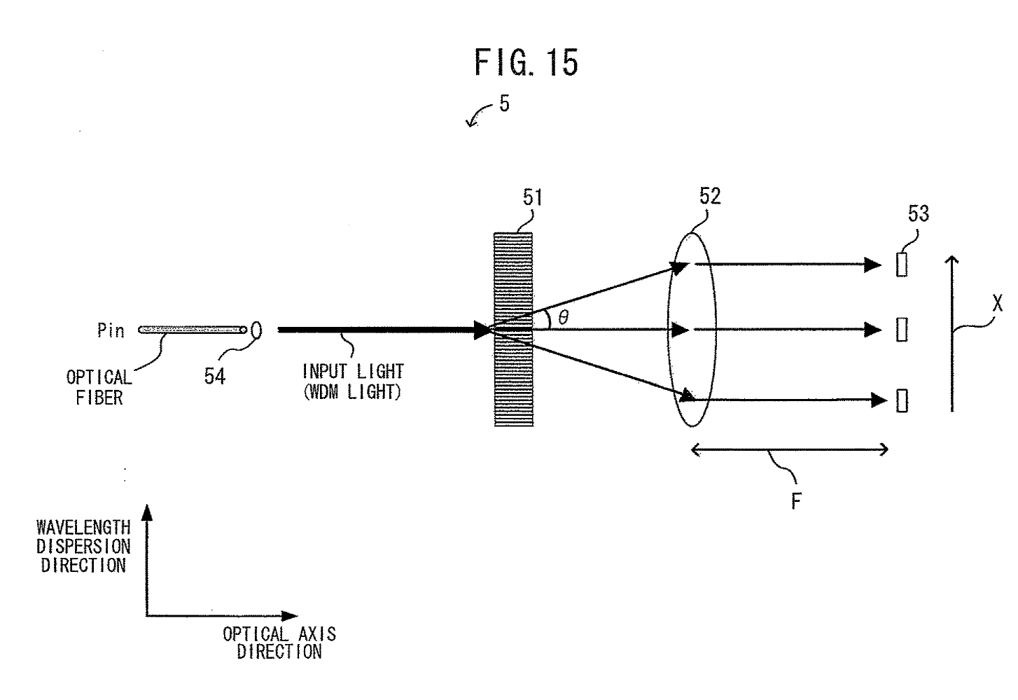

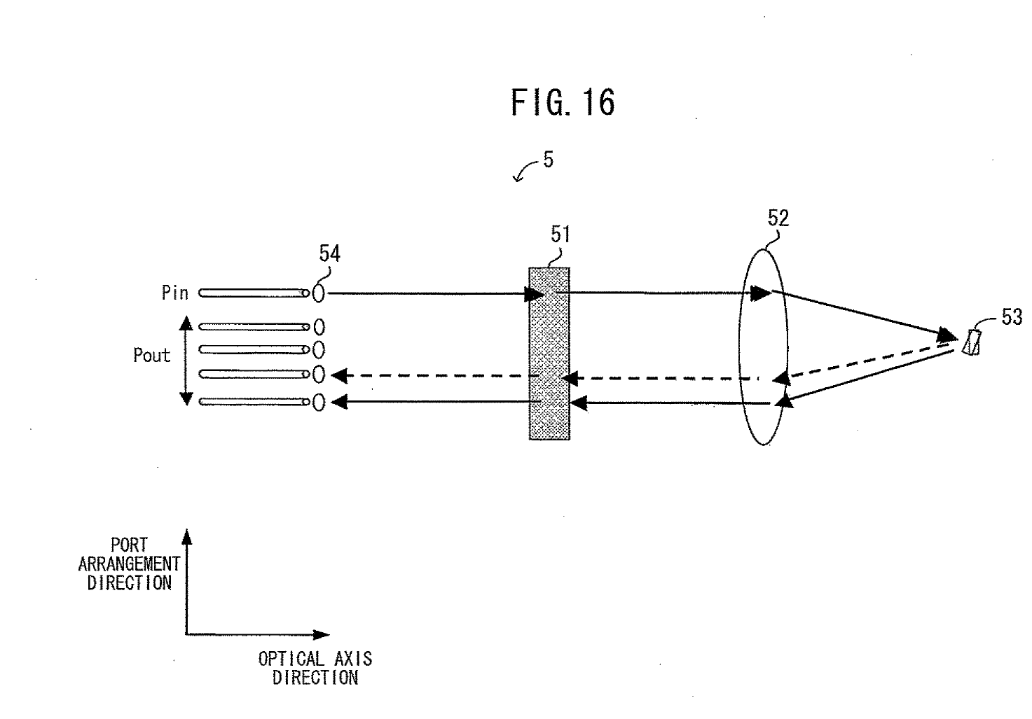

Next, a wavelength selective switch (WSS, hereinafter) is described below. FIGS. 15 and 16 illustrate an exemplary WSS. FIG. 15 is a diagram illustrating the WSS viewed in a plane (upper face) that contains the wavelength dispersion direction and the optical axis direction. FIG. 16 is a diagram showing a view in a plane (side face) that contains the port switching direction and the optical axis direction.

A WSS 5 includes a spectroscopy element 51, a condenser lens 52, a plurality of MEMS mirrors 53 arranged in the wavelength dispersion direction, a micro lens 54 for collimating light, an input port Pin, and output ports Pout (The optical elements such as the micro lens 54 arranged in the periphery of the ports are referred to as an input and output optical system, in some cases).

The wavelength multiplexed light generated by multiplexing a plurality of wavelengths input through the input port Pin undergoes spectroscopy in the spectroscopy element 51, and then collimated by the condenser lens 52 onto the MEMS mirrors 53 corresponding to the individual wavelengths.

Then, when the inclination (angles) of the MEMS mirrors 53 are changed, reflected light beams are output through arbitrary output ports Pout. In general, the spectroscopy element 51 includes a diffraction grating (referred to as a diffraction grating 51, hereinafter). The diffraction grating 51 is, in general, an element having a polarization-dependent loss. However, for example, when a K/4-plate is placed in front of the MEMS mirrors, this polarization-dependent loss is reduced.

Further, each of the MEMS mirrors 53 may be arranged in correspondence to each wavelength separated by the diffraction grating 51. Their inclination angles are variable. The output ports Pout for the individual wavelength components are determined in accordance with the inclination angles.

In FIG. 15, the incident angle of the beam onto the condenser lens 52 in the wavelength dispersion direction is denoted by θ. The focal length of the condenser lens 52 is denoted by F. Aberration in the condenser lens 52 is neglected. The wavelength dispersion directional position X of the beam on the MEMS mirror 53 may be expressed by the following Equation (9).

X=F×tan θ (9)

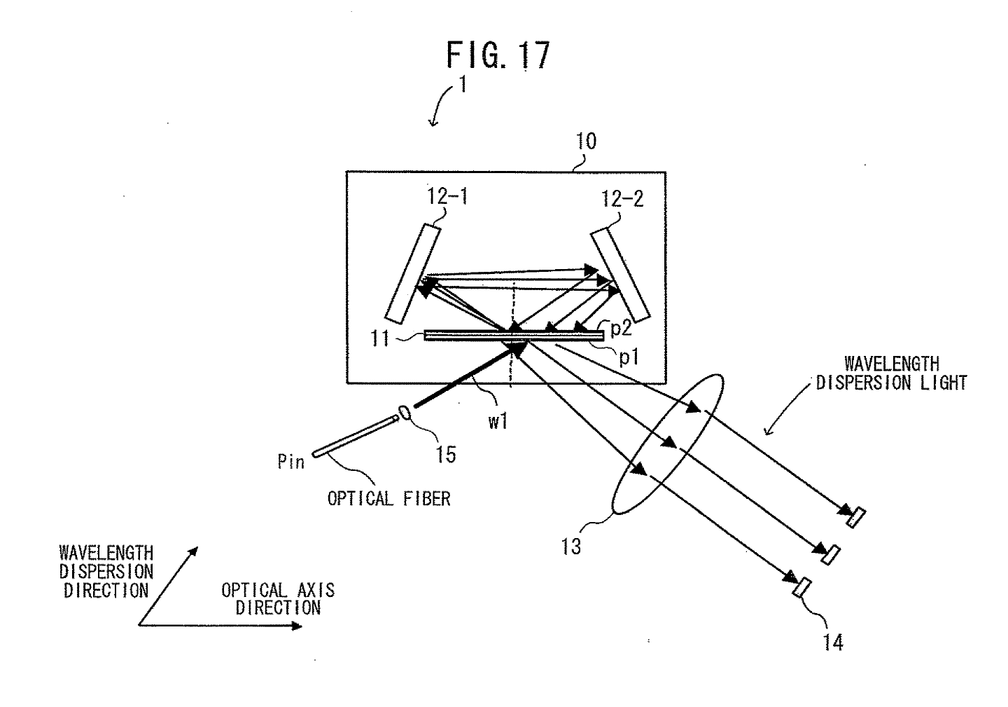

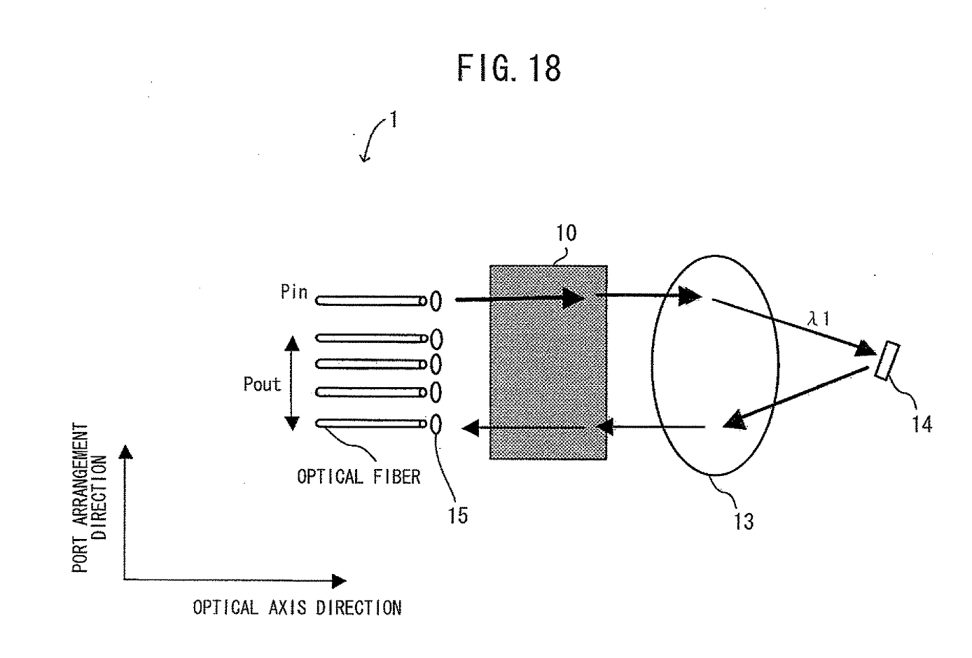

Next, a WSS that employs the optical device 10 is described below. FIGS. 17 and 18 illustrate the configuration of a WSS that employs the optical device 10. Here, FIG. 17 is a diagram showing a view in a plane that contains the wavelength dispersion direction and the optical axis direction. FIG. 18 is a diagram showing a view in a plane that contains the port switching direction and the optical axis direction (in FIG. 18, the light of wavelength λ1 transmitted through the diffraction grating is solely shown).

The WSS 1 includes one input port Pin, a plurality of output ports Pout, an optical device 10, a condenser lens 13, a movable reflection section 14, and a micro lens 15 for collimating light.

The condenser lens 13 collimates the diffracted light signals emitted from the optical device 10 (final diffracted light emitted from the plane p1 of the diffraction grating 11) onto the mirrors of the movable reflection section 14 for individual wavelengths.

The movable reflection section 14 includes mirrors arranged in correspondence to the individual dispersed wavelengths. Then, when the angles of the mirrors are changed, diffracted light signals of arbitrary wavelengths are output through arbitrary output ports Pout (hereinafter, the movable reflection section 14 is referred to as MEMS mirrors 14).

The WSS 1 is constructed when the spectroscopy element 51 of the general WSS 5 described above in FIGS. 15 and 16 is replaced by the optical device 10 (the configuration of the optical device 10 has been described above, and hence detailed description is omitted). Here, FIGS. 17 and 18 illustrate a configuration where a plurality of output ports and one input port are provided. However, a configuration where one output port and a plurality of input ports are provided or the like may be employed. In this configuration, when the angle of the MEMS mirror 14 is changed, the light from one arbitrary input port among a plurality of input ports is solely output through the output port.

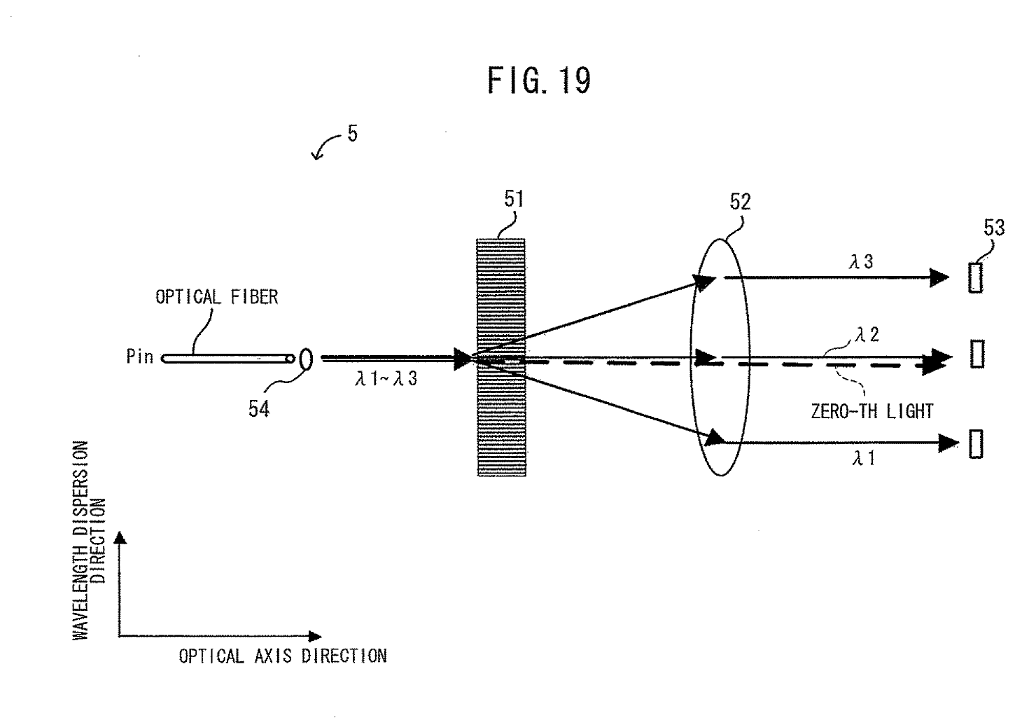

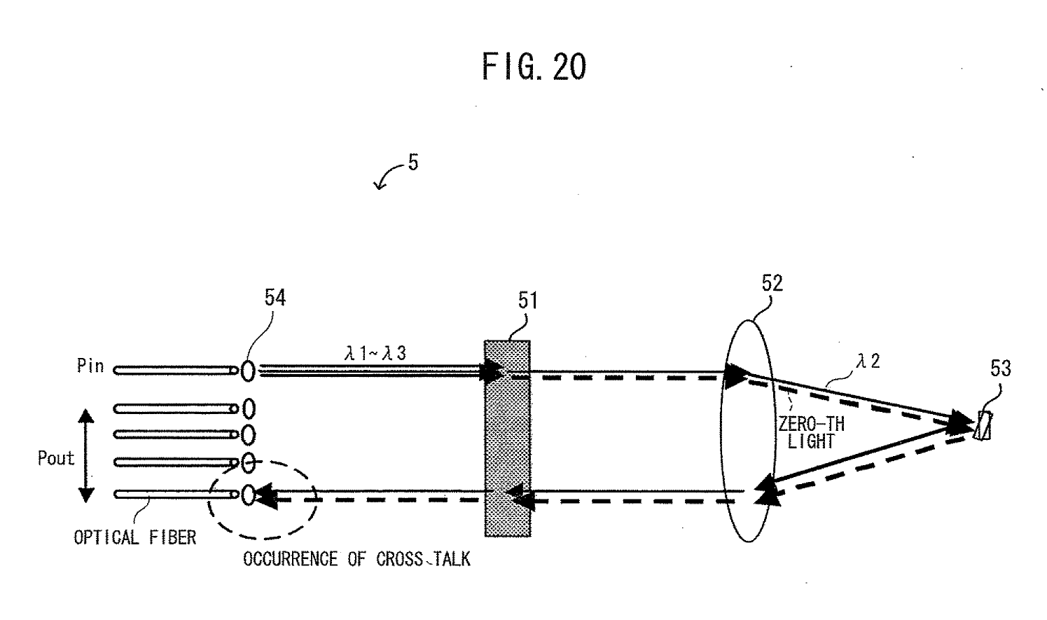

Cross talk occurring in the WSS is described below. FIGS. 19 and 20 illustrate a situation of occurrence of cross talk in the WSS 5. FIG. 19 is a diagram showing a view in a plane that contains the wavelength dispersion direction and the optical axis direction. FIG. 20 is a diagram showing a view in a plane that contains the port switching direction and the optical axis direction.

It is assumed that the emitting angle of the zero-th light from the diffraction grating 51 agrees with the diffraction angle of the light of wavelength λ2. In this case, in Equation (9), 0 is common to the zero-th light and the light of wavelength λ2. Thus, the wavelength dispersion directional position X of the beam on the MEMS mirrors 53 is also common to these.

Thus, the beams of the zero-th light and the light of wavelength λ2 are collimated at the same wavelength dispersion directional position of the MEMS mirrors 53 (that is, collimated onto the same MEMS mirror). Thus, as seen from FIG. 20, the zero-th light is output to the same output port Pout as the light of wavelength λ2. This causes cross talk.

The feature of suppressing cross talk in the WSS 1 is described below. When the optical device 10 is singly taken into consideration, cross talk is avoided when the configuration satisfies the relations of Equations (7a) and (7b).

However, when the optical device 10 is applied to a WSS, a MEMS mirror may be arranged in the downstream. Thus, unless the zero-th light goes outside the MEMS mirror, cross talk described in FIGS. 19 and 20 occurs. Thus, Accordingly, also in the WSS 1 that employs the optical device 10, the optical path of the zero-th light needs to go outside the MEMS mirror.

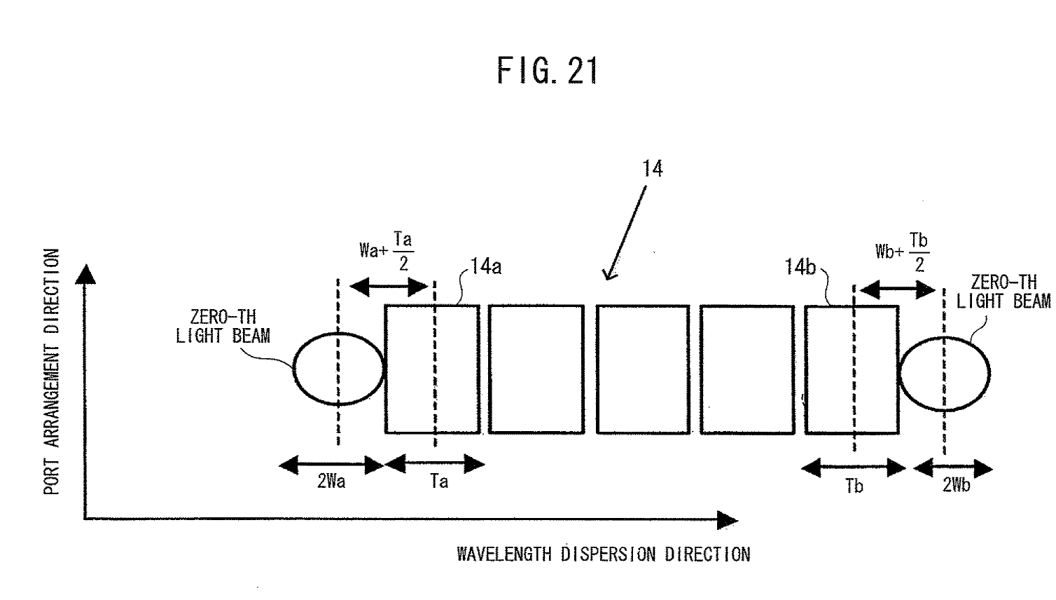

FIG. 21 illustrates a case when the optical path of the zero-th light goes outside the MEMS mirror 14. The left-hand side of the MEMS mirror 14 is the short wavelength side, while the right-hand side is the long wavelength side. In order that cross talk by the zero-th light should be avoided completely, as shown in the figure, the beam diameter of the zero-th light needs to be located outside the MEMS mirror 14a at the short wave end or alternatively outside the MEMS mirror 14b at the long wave end.

The mirror width of the MEMS mirror 14a at the short wave end is denoted by Ta. The mirror width of the MEMS mirror 14b at the long wave end is denoted by Tb. The Gaussian beam diameter of the zero-th light on the short wave end side is denoted by Wa. The Gaussian beam diameter of the zero-th light on the long wave end side is denoted by Wb. Then, in general, in a Gaussian beam, no substantial optical power is present in a region outside the twice of the diameter. Thus, as seen from Equations (7a), (7b), and (9), it is sufficient that any one of the following Equations (10a) and (10b) is satisfied.

F×tan(θout(λa)−θin−A)>Wa+Ta/2 (10a)

F×tan(θin+A−θout(λb))>Wb+Tb/2 (10b)

When any one of the conditions is satisfied, the zero-th light beam completely goes outside the MEMS mirror 14, and hence cross talk can be avoided.

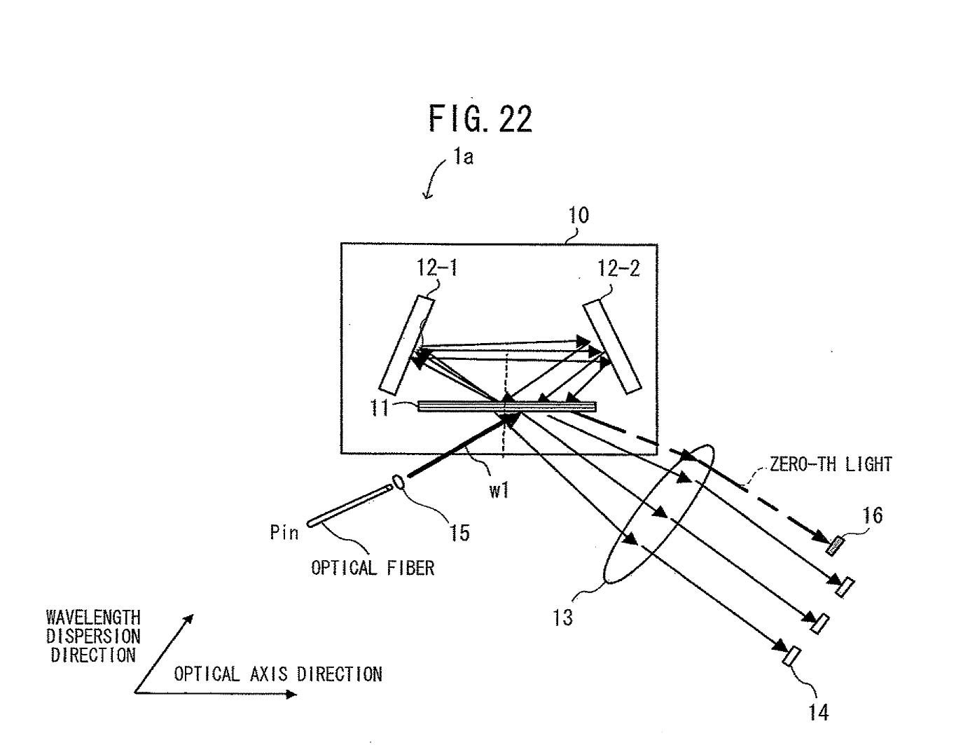

FIG. 22 illustrates a WSS having a light shielding mask. In the WSS 1a, a light shielding mask 16 may be arranged in the optical path of the zero-th light. The other points concerning the configuration are the same. When the configuration satisfies Equations (10a) and (10b), the zero-th light does not enter the MEMS mirror 14. Nevertheless, in the vicinity of the MEMS mirror 14, a wiring board for driving the MEMS mirror 14, a package for accommodating the MEMS mirror 14, and the like are present.

Thus, when the zero-th light enters these parts, cross talk can be caused by the influence of scattering and the like. Then, in the WSS 1a, the light shielding mask 16 is provided in the optical path of the zero-th light so that the light shielding mask 16 absorbs the zero-th light and thereby avoids cross talk more reliably.

The above-mentioned argument concerning cross talk has treated the relation between diffracted light of a particular degree of diffraction (the primary diffraction light having a high diffraction efficiency, for the purpose of highest generality in the above-mentioned example) and the zero-th light. Nevertheless, in the diffraction grating, higher order diffracted light such as secondary diffracted light is also present.

However, light employed in the field of optical communication may have a long wavelength. Further, in the optical device 10, the smaller grid period d of the diffraction grating 11 is more desirable as described above. Thus, diffracted light of higher order than that shown in Equation (1) may have a large diffraction angle, and hence suffers total reflection in the rear face inside the diffraction grating 11. Thus, such light is almost completely not transmitted. Accordingly, in practice, it is sufficient that the influence of the zero-th light is solely taken into consideration as the cause of cross talk.

As described above, according to an exemplary optical device 10 and the WSS 1, high-quality wavelength dispersion or wavelength switching can be performed in which angular dispersion is enhanced efficiently at a low cost and in which suppression of the cross talk is prevented.

In an exemplary embodiment, a unit having a configuration that the incident angle and the position at the time when wavelength dispersion light diffracted at the first time by a transmission type diffraction grating re-enters the same diffraction grating can be changed arbitrarily and/or a unit employing two or more light deflection sections may be referred to as a light deflection unit.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An optical device comprising.
a diffraction grating having first and second planes; and
first and second reflecting planes located on a second plane side of the diffraction grating, wherein light input to the first plane of the diffraction grating is diffracted, and then an optical path of the diffracted light is re-input to the second plane of the diffraction grating newly via the first and the second reflecting planes.

2. The optical device according to claim 1, wherein a distance between the first and the second reflecting planes is greater than a width of the diffraction grating.

3. The optical device according to claim 1, wherein a distance between the first and the second reflecting planes is greater than a distance between an output position of the diffracted light from the second plane and a position of reentrance of the diffracted light into the second plane.

4. The optical device according to claim 1, wherein light input to the first plane and light output from the first plane do not overlap with each other in a space on the first plane side.

5. The optical device according to claim 1, further comprising a prism, wherein the first and the second reflecting planes are constructed from the prism that reflects input light.

6. The optical device according to claim 1, further comprising a concave mirror, wherein the first and the second reflecting planes are constructed from the concave mirror that reflects input light.

7. An optical device comprising:
a diffraction grating having first and second planes; and
first and second reflecting planes located on a second plane side of the diffraction grating, wherein a plane direction of the diffraction grating is adopted as the x-axis while a perpendicular line to this plane is adopted as the y-axis, then in a space extending from the first quadrant to the fourth quadrant defined by adopting as the origin a position where the light is input to the first plane of the diffraction grating,
when in input to the first plane of the diffraction grating, an optical path that goes from the lower left to the origin located in the upper right is assumed as located in the third quadrant, the diffraction grating diffracts the light input to the first plane so as to output diffracted light in the second quadrant, then the first and the second reflecting planes deflect the optical path of the input diffracted light so as to re-input the light to the second plane of the diffraction grating, and then the re-input diffracted light is diffracted further and output in a direction of the fourth quadrant.

8. The optical device according to claim 7, wherein a distance between the first and the second reflecting planes is greater than a width of the diffraction grating.

9. The optical device according to claim 7, wherein a distance between an output position of the diffracted light from the second plane and a position of reentrance of the diffracted light into the second plane is smaller than a distance between the first and the second reflecting planes.

10. The optical device according to claim 7, wherein light input to the first plane and light output from the first plane do not overlap with each other in a space on the first plane side.

11. The optical device according to claim 7, further comprising a prism, wherein the first and the second reflecting planes are constructed from the prism that reflects input light.

12. The optical device according to claim 7, further comprising a concave mirror, wherein the first and the second reflecting planes are constructed from the concave mirror that reflects input light.

13. A wavelength selective switch for performing switch processing for a light signal on a wavelength basis, the wavelength selective switch comprising:
an optical device including:
one input port,
a plurality of output ports,
a diffraction grating having first and second planes, and
first and second reflecting planes located on the second plane side of the diffraction grating, wherein
wavelength multiplexed light input through the input port to the first plane of the diffraction grating is diffracted so that first diffracted light is output from the second plane, wherein the optical path of the first diffracted light is re-input to the second plane of the diffraction grating newly via the first and the second reflecting planes, and wherein second diffracted light having been diffracted further is output from the first plane,
a condenser lens for condensing the second diffracted light output from the optical device; and
a movable mirror array for reflecting the light condensed by the condenser lens so as to change its angle and thereby outputting light of an arbitrary wavelength among the second diffracted light through an arbitrary output port.

14. The wavelength selective switch according to claim 13, wherein when:
an incident angle of the wavelength multiplexed light onto the first plane is denoted by θin;
as for zero-th light among the light diffracted by the diffraction grating, an angle difference between an emitting angle of the zero-th light going from the second plane to the light deflection unit and an incident angle of the zero-th light going from the light deflection unit to the second plane is denoted by A;
a minimum wavelength and a maximum wavelength of the wavelength multiplexed light are denoted by λa and λb, respectively; a diffraction angle of the second wavelength dispersion light having the minimum wavelength λa is denoted by θout(λa);
a diffraction angle of the second wavelength dispersion light having the maximum wavelength λb is denoted by θout(λb); a focal length of the condenser lens is denoted by F;
a width of the movable reflection mirror located at a short wave end is denoted by Ta; a width of the movable reflection mirror located at a long wave end is denoted by Tb;
a Gaussian beam diameter of the zero-th light on a short wave end side is denoted by Wa;
and a Gaussian beam diameter of the zero-th light on the long wave end side is denoted by Wb, the following relations are satisfied:
F×tan(θout(λa)−θin−A)>Wa+Ta/2
F×tan(θin+A−θout(λb))>Wb+Tb/2

15. The wavelength selective switch according to claim 13, wherein
a light shielding mask for shielding the zero-th light is arranged in an optical path of the zero-th light among the light diffracted by the diffraction grating.

16. A wavelength selective switch for performing switch processing for a light signal on a wavelength basis, the wavelength selective switch comprising
an optical device including:
one output port,
a plurality of input ports,
a diffraction grating having first and second planes, and
the first and the second reflecting planes located on the first plane side of the diffraction grating, wherein
wavelength multiplexed light input through the plurality of input ports to the first plane of the diffraction grating is diffracted so that first diffracted light is output from the second plane, wherein the optical path of the first diffracted light is re-input to the second plane of the diffraction grating newly via the first and the second reflecting planes, and wherein second diffracted light having been diffracted further is output from the first plane;
a condenser lens for condensing the second diffracted light output from the optical device; and
a movable mirror array for reflecting the light condensed by the condenser lens so as to change its angle and thereby outputting light of an arbitrary wavelength among the second diffracted light through an arbitrary output port.

17. The wavelength selective switch according to claim 16, wherein when:
an incident angle of the wavelength multiplexed light onto the first plane is denoted by θin; as for zero-th light among the light diffracted by the diffraction grating, an angle difference between an emitting angle of the zero-th light going from the second plane to the light deflection unit and an incident angle of the zero-th light going from the light deflection unit to the second plane is denoted by A;
a minimum wavelength and a maximum wavelength of the wavelength multiplexed light are denoted by λa and λb, respectively;
a diffraction angle of the second wavelength dispersion light having the minimum wavelength λa is denoted by θout(λa);
a diffraction angle of the second wavelength dispersion light having the maximum wavelength λb is denoted by θout(λb); a focal length of the condenser lens is denoted by F;
a width of the movable reflection mirror located at a short wave end is denoted by Ta;
a width of the movable reflection mirror located at a long wave end is denoted by Tb;
a Gaussian beam diameter of the zero-th light on a short wave end side is denoted by Wa; and a Gaussian beam diameter of the zero-th light on the long wave end side is denoted by Wb, the following relations are satisfied:
F×tan(θout(λa)−θin−A)>Wa+Ta/2
F×tan(θin+A−θout(λb))>Wb+Tb/2

18. The wavelength selective switch according to claim 16, wherein
a light shielding mask for shielding the zero-th light may be arranged in an optical path of the zero-th light among the light diffracted by the diffraction grating.
